(19) United States
(12) Patent Application Publication
(10) Pub. No.: US 2026/0195122 A1
(43) Pub. Date: Jul. 9, 2026

(54) SYSTEMS AND METHODS FOR A BRANCH REMOVAL TOOL

(71) Applicant: JPMORGAN CHASE BANK, N.A., New York, NY (US)

(72) Inventors: Dinesh Babu PARTHASARATHI, Bournemouth (GB); Anurag RASTOGI, Bournemouth (GB); Sudharsan VEERASEKARAN, Bengaluru (IN); K MANIKANDAN, Bengaluru (IN); Anitha RAJASEELI, New York, NY (US)

(21) Appl. No.: 19/060,261

(22) Filed: Feb. 21, 2025

(30) Foreign Application Priority Data
Jan. 3, 2025 (IN) 202511000676

(51) Int. Cl. G06F 8/71; G06F 16/2455; G06F 40/30

(52) U.S. Cl. CPC G06F 8/71; G06F 16/2455; G06F 40/30

(57) ABSTRACT

In some embodiments, the techniques described herein relate to a method including: creating, by a computer application executed by the processor and operatively connected to an organization's network, an execution identification of a segment of the organization's network; determining, by the computer application, a first table of the organization's network associated with the segment based on a search of a name of the segment; backing up, by the computer application, the first table; removing, by the computer application, the first table from the organization's network; determining, by the computer application, to continue the removal of the segment based on a successful run of an application dependent on the first table; and verifying, by the computer application, the deletion of the first table, the intraorganizational parameter, and the table entry in the organization's network and the back up memory.

### RELATED APPLICATIONS

This application claims the benefit of Indian Provisional Patent Application Ser. No. 202511000676, filed Jan. 3, 2025. The disclosure of each of these applications is hereby incorporated, by reference, in its entirety.

### BACKGROUND

### 1. Field of the Invention

Embodiments generally relate to systems and methods for removing a branch and associated dependencies.

### 2. Description of the Related Art

Large organizations have significant software and hardware structures that support a variety of business services. A software and/or hardware segment may need to be separated from those large structures, for example, due to a reorganization, sale, or other event. However, due to the large number of dependencies of modern software structures, the separation may be difficult to complete while maintaining the dependencies. Significant manual effort is required to correct the broken dependencies, to copy and save data in correct locations, and create new connections to internal or external resources. Further, the separation may take significant manual resources of experienced persons. Thus, there is a need for an improved tool to move a separated structure while maintaining dependencies. There is also a need to move the separated structure in a quick, efficient manner.

### SUMMARY

In some embodiments, the techniques described herein relate to a method that may include one or more steps of: creating, by a computer application executed by the processor and operatively connected to an organization's network, an execution identification of a segment of the organization's network; determining, by the computer application, a first table of the organization's network associated with the segment based on a search of a name of the segment; determining, by the computer application, a second table of the organization's network associated with the segment based on a table entry of a name of the segment; determining, by the computer application, an intraorganizational parameter accessed by more than one application, each application associated with more than one segment of the organization's network; removing, by the computer application, the name of the segment from the intraorganizational parameter and the table entry from the organization's network; backing up, by the computer application, the first table, the intraorganizational parameter, and the table entry in a back up memory; removing, by the computer application, the first table from the organization's network; testing, by the computer application, each application; determining, by the computer application, to continue the removal of the segment based on a successful run of each application; and verifying, by the computer application, the deletion of the first table, the intraorganizational parameter, and the table entry in the organization's network and the back up memory.

In some embodiments, the search of the name of the segment may comprise a semantic search, by a machine learning engine, of similarities of the name of the segment. In some embodiments, the search of the name of the segment may comprise a search for a matching attribute associated with the segment. In some embodiments, the method may further comprise renaming the first table name to an archive name in the back up memory. In some embodiments, the method may further comprise validating the renamed tables by running a structured query language (“SQL”) query to ensure the first table is renamed. In some embodiments, the method may further comprise conducting a pre-validation to check a new database table for consistency against the existing table. In some embodiments, the method may further comprise generating a flat table, wherein the flat table includes an order of each table entry to be removed from the organization's network and a level for each table entry to be removed from the organization's network. In some embodiments, the method may further comprise removing each table entry in the level and then the order of the flat table. In some embodiments, the level may be based on a section denoted in the table, the denotation occurring based on a title in the table. In some embodiments, the level may be based on a section denoted in the table, the denotation occurring based on a row separation in the table. In some embodiments, the order may be based on a number of dependencies by one or more applications.

In some embodiments, the method may further comprise determining, by a machine learning engine, a format of the table entry based on a semantic similarity of the table entry as compared to a code format. In some embodiments, the semantic similarity may be based on a number of characters of the table entry and the code format. In some embodiments, the semantic similarity may be based on a placement of punctuation in the table entry and the code format. In some embodiments, the semantic similarity may be based on a presence of a word in the table entry and the code format.

Embodiments consistent with the present disclosure include a system comprising one or more processors and one or more storage devices storing instructions that when executed by one or more processors, cause the processor to perform one or more steps of the methods disclosed herein. Embodiments consistent with the present disclosure include a computer processing system, computer, or server, comprising: a memory configured to store instructions; and a hardware processor operatively coupled to the memory for executing the instructions to perform one or more steps of the methods disclosed herein. An organization's network may comprise one or more computers and/or servers with one or more applications executed thereon.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a system for branch removal, in accordance with embodiments.

FIG. 2 is a flowchart of a method for software removal, in accordance with embodiments.

FIG. 3 is a flowchart of a method for software removal, in accordance with embodiments.

FIG. 4 is a block diagram of a technology infrastructure and computing device for implementing certain embodiments of the present disclosure, in accordance with embodiments.

### DETAILED DESCRIPTION

Embodiments generally relate to systems and methods for removing a branch and associated dependencies.

Embodiments may include a computer program including a branch removal tool. The computer program may operate on an organization's network. The organization's network may support different segments. In some embodiments, the different segments may be branches. The segments may be partitioned from each other. The segments may include databases specific to the segments. Embodiments consistent with the present disclosure resolve difficulties with removing or moving a segment from an organization's network. The difficulties may include broken functionalities, moving unnecessary data, losing files while performing a move, and significant cost and manual labor. Embodiments consistent with the present disclosure include a robust implementation model with clean data removal from shared tables as well as segment-specific tables. Embodiments consistent with the present disclosure may isolate data specific to the segment to reduce costs and optimize data cleaning. Embodiments may allow a reduction of objects in a database.

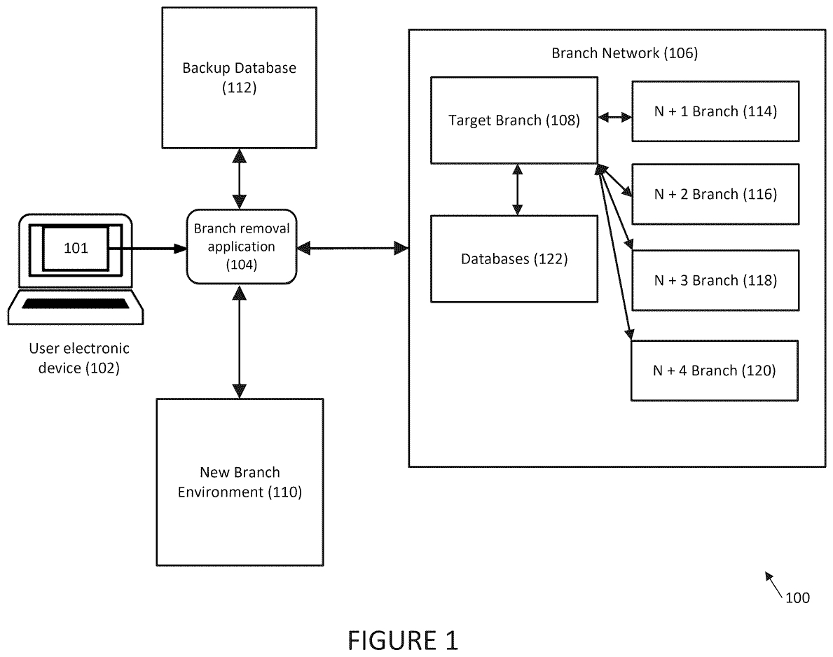

FIG. 1 illustrates a system for software removal, in accordance with embodiments.

System 100 may include a user electronic device 102, a branch removal application 104, a branch network 106, a new branch environment 110, and/or a backup database 112. The user electronic device 102 may include one or more processors configured to execute a branch removal application 104. The user electronic device 102 may include a user interface 101 to receive user inputs and display outputs consistent with disclosed embodiments. The branch removal application may access branch network 106.

Branch network 106 may include one or more branches including a target branch 108, n+1 branch 114, n+2 branch 116, n+3 branch 118, and n+4 branch 120. Branch network 106 may include more branches than those illustrated. The branches 108, 114, 116, 118, and 120 may access one or more databases 122, particularly for operation of one or more functions of the target branch. In some embodiments, branch network 106 may be a franchise network, a financial institution, or another organization network. Target branch 108 may include one or more connections and/or dependencies to other branches 114, 116, 118, 120 and/or databases 122 that may require significant manual effort to unravel before target branch 108 may be deleted and/or moved to a new branch environment 110.

Each of target branch 108, n+1 branch 114, n+2 branch 116, n+3 branch 118, and n+4 branch 120 may include one or more computers, instances, or servers of a local network. Branch network 106 may include one or more computers or servers connected to each of the target branch 108, n+1 branch 114, n+2 branch 116, n+3 branch 118, and n+4 branch 120. In some embodiments, target branch 108 may access branches 114, 116, 118, 120 or vice versa to share information, the access occurring through one or more application programming interfaces (APIs), private API gateways, and/or one or more communication protocols.

Databases 122 may include one or more memories of a computer network and/or of a cloud-based network. The one or more memories may be non-transitory. Databases 122 may include an internal memory, of branch network 106, and/or an external memory in operative communication with one or more branches 108, 114, 116, 118, 120.

Back-up database 112 may include one or more memories of a computer network and/or of a cloud-based network. The one or more memories may be non-transitory.

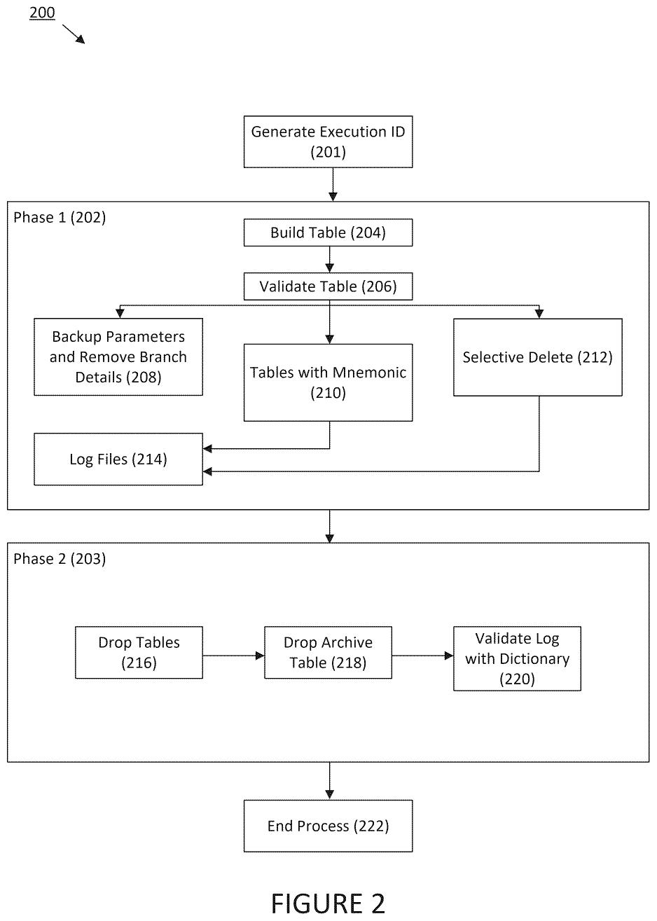

FIG. 2 illustrates a flowchart of a method for software removal, in accordance with embodiments.

In some embodiments, the method may be a set of instructions that, when executed by a processor, may cause the processor to: create an execution identification; prepare a new database table name for each existing table name file associated with an existing table of a target branch, wherein the existing table is found by searching for an organization name or an organization identification associated with an organization; conduct pre-validation to check a new database table for consistency against the existing table; update a status to “do not use” in the existing table; back up a parameter to configure the list of the organization on a backup database; remove a company name from the parameter; determine if a transfer should continue, and if not, then restore the parameter, but if so, then take no action; generate a list of existing tables to be renamed; rename the existing tables displayed in the list of existing tables; validate the renamed tables by running a structured query language (“SQL”) query to ensure the existing table is renamed; generate a flat table, wherein the flat table includes an order of each record to be removed and a level for each record to be removed; run a branch removal executable program for a customer, an account, and/or a company; validate deletion of a selective table; drop and/or delete the existing tables; validate that existing tables are deleted; restore a new database table that has been renamed; and re-validate the new database table by running a SQL query against the deleted record to ensure a count of records is matched (e.g., a count of records based on a number of deleted records or a count of remaining records). The “do not use” status may render the table or parameter unusable. The level may be based on a section denoted in the table, the denotation occurring based on a title in the table, a row and/or a column separation in the table, and/or a unique identifier. The order may be based on a number of dependencies by one or more applications.

In some embodiments, an organization database may include a voice of the consumer (VOC) entry. The VOC entry may be transferred from the organization database to a new database or deleted. Each VOC entry may be renamed and validated. VOC entries may be deleted in an organization's database and validated. The VOC entries may be restored to the organization's database on completion.

Method 200 may be a method for removal of a segment of an organization's network. The segment may be a branch segment. The organization's network may be a number of computers connected over a network such as the internet, a virtual private network, or a local network.

Method 200 may include step 201 of generating an execution identification for a segment selected to be deleted. Method 200 may include a phase 1 (202) and a phase 2 (203). Phase 1 (202) may be a preparation phase and phase 2 (203) may be an execution phase. Phase 1 (202) may include identifying tables to be deleted was identified based on a table name. The table name may include an organization mnemonic/shorthand in the table name. In some embodiments, in phase 1 (202), the computer application may rename the identified tables as a back up table (e.g., with a prescript or postscript of “ARCHIVE”). Phase 1 (202) may include deleting selective data that is identified based on the organization mnemonic/shorthand.

In some embodiments, a machine learning engine may identify the organization mnemonic/shorthand of the selective data based on a list of known attributes about the organization including one or more of the organization name, address, nickname, affiliate(s), subsidiary, abbreviation, country, unique identifier, tax identifier, or personnel. The machine learning engine may generate a semantic score of a similarity of a known attribute. In some embodiments, the computer application may require a threshold semantic score of a first word and at least one match of a second word. Thus, a number of typos, errors, or complex field entries may be captured without manual review, and an efficiency of the method is improved. The machine learning engine may be trained based on historical examples of similarities between an organization name and organization mnemonics/shorthands.

The selective data may be captured in one field of a plurality of fields in the identified tables. The field may be identified in the field even if a table is not identified based on the organization mnemonic/shorthand. In phase 1 (202) the computer application may select the back up of the records in the archive table and delete it. After successful validation of continuity-of-business (COB), in phase 2 (203), the computer application may drop the back up records and tables created in phase 1 (202).

Method 200 may include step 204 of generating a table (204). The table may comprise tables to be dropped or delete specific records among tables or records to be maintained. The table may comprise a list of documents from a file location. In some embodiments, the file location may be selected by a user.

At step 206, the table may be validated. The table may be validated by a coding dictionary to keep a format standard. In some embodiments, the table may be validated based on a mnemonic/shorthand of an organization. In some embodiments, a machine learning engine may be configured to determine a format based on a semantic similarity of an entry of the table and a related code format. The semantic similarity may be based on a number of characters of the entry, a title/unique identifier of a row and/or a column, a placement of punctuation, a unique identifier of each entry, and/or a word in the entry.

At step 208, an intraorganizational parameter may be backed up and removed. To be backed up, the intraorganizational parameter may be stored on a memory accessible by the computer application as a backed up intraorganizational parameter. The intercompany parameter may be accessed by more than one organization for one or more functions, such as a client information tracker, a third-party application login, an administrative management application, a customer service solution, a middleware, an intraorganizational communication application, a financial operation and/or transaction software, a business mapping application, a fraud detection software, and/or an encryption software. The intraorganizational parameter may be edited to remove one or more mnemonic/shorthand of the organization from the intraorganizational parameter. The backed up intraorganizational parameter may be restored in the case of a no-go scenario where the one or more functions fail to function with the intraorganizational parameter removed.

At step 210, an archive log may be generated using objects/tables that have organization mnemonic/shorthand in titles or entries, based on a semantic similarity as discussed herein, and the objects/tables will be renamed and stored in the archive log. The stored objects/tables in the archive log, and the removal of the same, may be validated by conducting searches for each object/table from the archive and the tables/objects.

At step 212, a flat table may be generated. The flat table may include one or more table/object names which do not have organization mnemonic/shorthand, in which case a record/object will be identified using an organizational mnemonic/shield in one of the fields/text of the table/object and will back up the record in the memory and delete the same from the table/object. The table/object names may be verified in the back up and in the table/object by conducting searches for each field/text in the back up and the table/object to ensure successful storage and removal.

At step 214, a number of log files may be stored on a memory. All the table changes as part of step 210 and/or 212 will be logged in the log table for validation.

Phase 2 may include steps 216, 218, and 220. Step 216 may include dropping tables using a log after test analysis. A number of applications may be executed after the removal of the intraorganizational parameter, the one of the fields/text, and the table to ensure operation (e.g., a COB test). After a COB test, step 218 may include dropping an archive table. Step 220 may include validating the log to ensure the identified tables are removed. In some embodiments, a semantic similarity search may be executed by a machine learning engine to verify each table and/or field/text associated with the segment to be deleted and/or removed and moved.

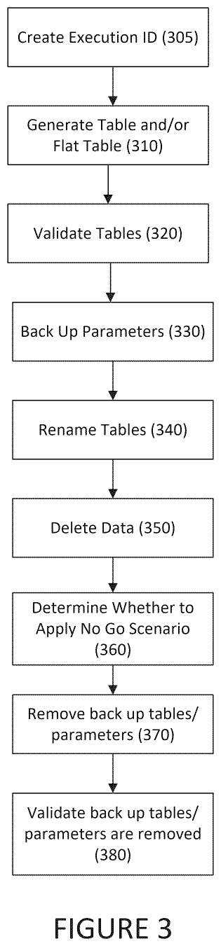

FIG. 3 illustrates a flowchart of a method for software removal, in accordance with embodiments.

The method may be executed by a computer application executed by one or more processors. The computer application may be in operative communication with an organization's network comprising one or more segments.

Step 305 may include creating an execution identification for a segment (e.g., branch) of an organization's network to be moved or removed. The execution identification may include an organization mnemonic/shorthand and timestamp. The execution identification may comprise a version identifier of the computer application.

Step 310 includes generating table/flat table associated with the segment. The table may comprise tables to be dropped or delete specific records among tables or records to be maintained. The table may comprise a list of documents from a file location. In some embodiments, the file location may be selected by a user. In the case of a flat table, the flat table may include one or more table/object names which do not have organization mnemonic/shorthand, in which case a record/object will be identified using an organizational mnemonic/shield in one of the fields/text of the table/object and will back up the record in the memory and delete the same from the table/object. The table/object names may be verified in the back up and in the table/object by conducting searches for each field/text in the back up and the table/object to ensure successful storage and removal.

Step 320 includes validating the table/flat table associated with the segment. The table and one of the fields/text may be validated by a coding dictionary to keep a format standard. In some embodiments, the table and one of the fields/text may be validated based on a mnemonic/shorthand of an organization. In some embodiments, a machine learning engine may be configured to determine a format based on a semantic similarity of an entry of the table and a related code format. The semantic similarity may be based on a number of characters of the entry, a title/unique identifier of a row and/or a column, a placement of punctuation, a unique identifier of each entry, and/or a word in the entry.

Step 330 includes storing a backup parameter. The backup parameter may be an intraorganizational parameter. To be backed up, the intraorganizational parameter may be stored on a memory accessible by the computer application as a backed up intraorganizational parameter. The intercompany parameter may be accessed by more than one organization for one or more functions, such as a client information tracker, a third-party application login, an administrative management application, a customer service solution, a middleware, an intraorganizational communication application, a financial operation and/or transaction software, a business mapping application, a fraud detection software, and/or an encryption software. The intraorganizational parameter may be edited to remove one or more mnemonic/shorthand of the organization from the intraorganizational parameter. The backed up intraorganizational parameter may be restored in the case of a no-go scenario where the one or more functions fail to function with the intraorganizational parameter removed.

Step 340 includes renaming a table and/or field or entry. The table and/or field or entry will be renamed and stored in the archive log. The stored objects/tables in the archive log, and the removal of the same, may be validated by conducting searches for each object/table from the archive and the tables/objects.

Step 350 includes deleting data from one or more tables and/or field or entries.

Step 360 may include determining whether to apply a no go scenario. A number of applications may be executed after the removal of the intraorganizational parameter, the one of the fields/text, and the table to ensure operation (e.g., a COB test). If the test is unsuccessful, the no go scenario may be implemented and the parameter, table, and/or field or entry may be restored from the back up. If the test is successful, the no go scenario may be discarded.

Step 370 includes removing back up tables/parameters.

Step 380 includes validating back up tables/parameters are removed. The validating may include checking the log to ensure the identified tables are removed. In some embodiments, a semantic similarity search may be executed by a machine learning engine to verify each table and/or field/text associated with the segment to be deleted and/or removed and moved.

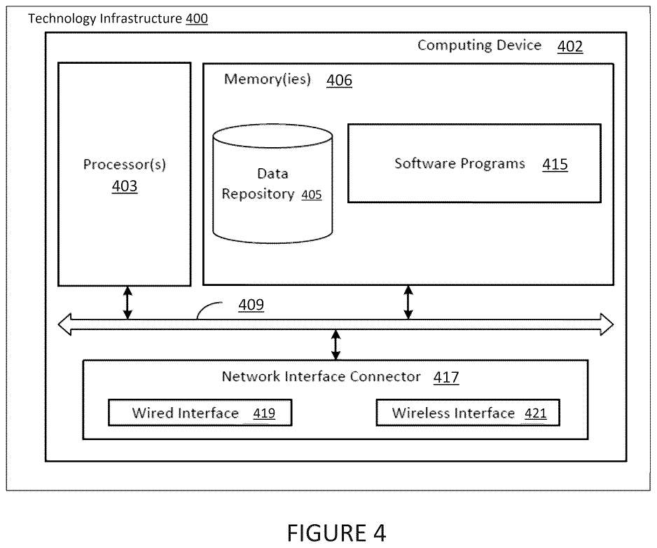

FIG. 4 is a block diagram of a technology infrastructure and computing device for implementing certain embodiments of the present disclosure, in accordance with embodiments. FIG. 4 includes technology infrastructure 400. Technology infrastructure 400 represents the technology infrastructure of an implementing organization. Technology infrastructure 400 may include hardware such as servers, client devices, and other computers or processing devices. Technology infrastructure 400 may include software (e.g., computer) applications that execute on computers and other processing devices. Technology infrastructure 400 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 400 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 400 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 400 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper of fiber optic wire/cable) that forms a physical computer network. Routers, switches, and firewalls may also have “wireless” interfaces that facilitate data transmissions via radio waves. A computer network included in technology infrastructure 400 may include both wired and wireless components and interfaces and may interface with servers and other hardware via either wired or wireless communications. A computer network of technology infrastructure 400 may be a private network but may interface with a public network (such as the internet) to facilitate operative communication between computers executing on technology infrastructure 400 and computers executing outside of technology infrastructure 400.

FIG. 4 further depicts exemplary computing device 402. Computing device 402 depicts exemplary hardware that executes the logic that drives the various system components described herein. Servers and client devices may take the form of computing device 402. While shown as internal to technology infrastructure 400, computing device 402 may be external to technology infrastructure 400 and may be in operative communication with a computing device internal to technology infrastructure 400.

In accordance with embodiments, system components such as a machine learning model, an API interface, a prompt interface, client devices, servers, various database engines and database services, and other computer applications and logic may include, and/or execute on, components and configurations the same, or similar to, computing device 402.

Computing device 402 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 306 may be coupled by a bus 409. In some examples, the bus 409 may also be coupled to one or more network interface connectors 417, such as wired network interface 419, and/or wireless network interface 421. Computing device 402 may also have user interface components, such as a screen for displaying graphical user interfaces and receiving input from the user, a mouse, a keyboard and/or other input/output components (not shown).

In accordance with embodiments, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API interfaces. A published API method may be called by an application that is authorized to access the published API method. API methods may take data as one or more parameters or arguments of the called method. In some embodiments, API access may be governed by an API interface associated with a corresponding API. In some embodiments, incoming API method calls may be routed to an API interface and the API interface may forward the method calls to internal services/modules/engines that publish the API and its associated methods.

A service/module/engine that publishes an API may execute a called API method, perform processing on any data received as parameters of the called method, and send a return communication to the method caller (e.g., via an API interface). A return communication may also include data based on the called method, the method's data parameters and any performed processing associated with the called method.

API interfaces may be public or private interfaces. A public API interface may accept method calls from any source without first authenticating or validating the calling source. A private API interface may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some embodiments of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method comprising a set of instructions that, when executed by a processor, cause the processor to:
creating, by a computer application executed by the processor and operatively connected to an organization's network, an execution identification of a segment of the organization's network;
determining, by the computer application, a first table of the organization's network associated with the segment based on a search of a name of the segment;
determining, by the computer application, a second table of the organization's network associated with the segment based on a table entry of a name of the segment;
determining, by the computer application, an intraorganizational parameter accessed by more than one application, each application associated with more than one segment of the organization's network;
removing, by the computer application, the name of the segment from the intraorganizational parameter and the table entry from the organization's network;
backing up, by the computer application, the first table, the intraorganizational parameter, and the table entry in a back up memory;
removing, by the computer application, the first table from the organization's network;
testing, by the computer application, each application;
determining, by the computer application, to continue the removal of the segment based on a successful run of each application; and
verifying, by the computer application, the deletion of the first table, the intraorganizational parameter, and the table entry in the organization's network and the back up memory.

2. The method of claim 1, wherein the search of the name of the segment comprises a semantic search, by a machine learning engine, of similarities of the name of the segment.

3. The method of claim 1, wherein the search of the name of the segment comprises a search for a matching attribute associated with the segment.

4. The method of claim 1, further comprising renaming the first table name to an archive name in the back up memory.

5. The method of claim 1, further comprising validating the renamed tables by running a structured query language (“SQL”) query to ensure the first table is renamed.

6. The method of claim 5, further comprising conducting a pre-validation to check a new database table for consistency against the existing table.

7. The method of claim 1, further comprising generating a flat table, wherein the flat table includes an order of each table entry to be removed from the organization's network and a level for each table entry to be removed from the organization's network.

8. The method of claim 7, further comprising removing each table entry in the level and then the order of the flat table.

9. The method of claim 7, wherein the level is based on a section denoted in the table, the denotation occurring based on a title in the table.

10. The method of claim 7, wherein the level is based on a section denoted in the table, the denotation occurring based on a row separation in the table.

11. The method of claim 7, wherein the order is based on a number of dependencies by one or more applications.

12. The method of claim 1, further comprising determining, by a machine learning engine, a format of the table entry based on a semantic similarity of the table entry as compared to a code format.

13. The method of claim 12, wherein the semantic similarity is based on a number of characters of the table entry and the code format.

14. The method of claim 12, wherein the semantic similarity is based on a placement of punctuation in the table entry and the code format.

15. The method of claim 12, wherein the semantic similarity is based on a presence of a word in the table entry and the code format.
